(19) United States
(12) Patent Application Publication
(10) Pub. No.: US 2019/0213003 A1
(43) Pub. Date: Jul. 11, 2019

(54) METHOD, SYSTEM AND SOFTWARE APPLICATION FOR DEVELOPING MOBILE APPLICATIONS

(71) Applicant: OBSCHESTVO S OGRANICHENNOI OTVETSTVENNOSTYU "MOBST RUS", Tyumen (RU)

(72) Inventors: Aleksey Vladimirovich Burlitskiy, Tyumen (RU); Denis Andreevich Volkov, Tyumen (RU); Stanislav Viktorovich Savransky, Tyumen (RU)

(21) Appl. No.: 16/333,365

(22) PCT Filed: Sep. 20, 2016
(86) PCT No.: PCT/RU2016/000631

§ 371 Date: Mar. 14, 2019

(51) Int. Cl. G06F 8/70; G06F 8/34

(52) U.S. Cl. CPC G06F 8/70; G06F 8/34

(57) ABSTRACT

The claimed invention relates to tools for building mobile applications, their management and distribution via various mobile data transfer channels, in particular, to a method, system and software application for performing the above actions. The claimed solution combines all the necessary services and tools for the development of mobile applications, and also implements a conversion system of the application program logic that allows to adapt the built mobile applications for any mobile channels of the application end users. A key feature of the claimed solution is the use of tools for building mobile applications in a given format, tools for converting the built mobile applications from one format to another, tools for transmitting the built applications via mobile data transfer channels in a given format for each channel, tools for communication and synchronization of applications, transmitted through the mobile data transfer channels.

### PRIOR ART

The claimed invention relates to tools for building mobile applications, their management and distribution via various mobile data transfer channels, in particular, to a method, system and software application for performing the above actions.

### BACKGROUND

Currently, there are various MADP (Mobile Application Development Platform) tools, or app building platforms (App Builders). The most famous of these systems are represented by Kony, iBuildapp, AppGyver, Telerik, Appcelerator, PhoneGap and other companies. There are systems for developing chat-bots for mobile messengers, for example, Chatfuel.

There are also mobile hosting systems, file hosting services, push notification services and version control under the umbrella term of MbaaS (Mobile Backend As A Service), for example, Kinvey, Oracle Mobile Cloud, etc.

The main disadvantage of existing solutions is a lack of a single platform that allows for the development of mobile applications to carry out their automated adaptation, in particular, the adaptation of program logic tied to the features of the application interface, for various mobile data transfer channels.

### SUMMARY

The claimed solution combines all the necessary services and tools for the development of mobile applications, and also implements a conversion system of the application program logic that allows adapting the built mobile applications for any mobile channels of the application end users.

In a first preferred embodiment of the claimed invention, a system for building and managing mobile applications is disclosed, comprising:

at least one processor;

at least one storage that contains program instructions that, when executed, implement on at least one processor

tool for building mobile applications in a given format;

tools for converting the built mobile applications from one format to another, which include at least an application program logic parser that analyses the interface elements of the application;

tools for transmitting the built applications through mobile data transfer channels in a given format for each channel;

tools of communication and synchronization of applications transmitted through mobile data transfer channels.

In one particular embodiment the tools for building mobile applications comprise a visual design mechanism that provides the building of an application using a set of application elements.

In another particular embodiment system comprise a content management system (CMS) for various mobile channels, which provides a centralized storage of applications, a graphical representation of the content, a logical representation of the content and the synchronization of the content and the operation logic between different mobile channels.

In another particular embodiment the graphical representation of the content is grouped depending on the type of the mobile channel and the dominant elements of the graphical interface of the application.

In another particular embodiment system contains means of communication with external information systems.

In another particular embodiment analysis of application elements using a parser includes: analysis of the degree of use of interface elements, combinations of interface elements, relations between interface elements.

In another particular embodiment the tools for converting the built mobile applications contain a means of recovery of the application's program logic for various mobile data transfer channels, which receives information from the parser, analyses the program logic of the application and determines the need to change the logic for a given mobile data transfer channel.

In another particular embodiment the tools for converting the built mobile applications contain a self-teaching mechanism designed to detect various tasks and determining the most frequently used settings of the application interface.

In another particular embodiment the self-teaching mechanism performs updating of the program logic parser.

In another particular embodiment the means for transmitting the built applications through the mobile data transfer channels comprise the data unification mechanism that provides an exchange of data between mobile channels in a unified form.

In another particular embodiment the tools for transmitting the built applications through mobile data transfer channels contain a tool for selecting a mobile data transfer channel and a mechanism for transmitting the program logic of the mobile channel corresponding to the parameters of the said channel and that performs a comparison of the application program version and mobile channel parameters.

In another particular embodiment the tools for transmitting the built applications through the mobile data transfer channels additionally comprise a means for seamless switching between different mobile data transfer channels.

In another particular embodiment the mechanism for transmitting program logic, based on the check performed, determines the correct version of the application's program logic for transmission through the selected mobile channel.

In another particular embodiment the means for transmitting the built applications through the mobile data transfer channels comprise the mechanism for the transfer of a appropriate content provides the transfer of the content version corresponding to the mobile data transfer channel API.

In another particular embodiment the tools of communication and synchronization of applications comprise a tool for analysing the technical parameters of mobile data transfer channels, and means for receiving responses from each of the APIs of mobile data transfer channels, as well as for distributing responses to maintain synchronization of mentioned mobile channels.

In another particular embodiment the tools of communication and synchronization of applications additionally comprise a tool for setting up a user mode of communication, which is selected from the group: global mode, mode for the selected mobile channel, mode for the type of mobile channel, mode for the selected application or combination thereof.

In another particular embodiment the tools for communication and synchronization of applications additionally comprise a medium for data storage and for communication with external information systems, which contains information about files, messages, statuses, user devices, user settings, UID, supported applications and mobile channels accessibility.

In another preferred embodiment of the claimed invention disclosed a computer-implemented method for building and managing mobile applications, comprising the following steps:

reception of the original application data using an application designer, which contains a set of application elements;

generation of an application program logic;

determination of a format of the mobile application's program logic depending on the type of a mobile data transfer channel, upon that at least it is performed the analysis of the API of the mobile channel through which it is necessary to transmit the program logic to determine the format of the application's program logic and a parameters of the application interface elements;

conversion of the application's program logic depending on the mobile data transfer channel API;

representation of the mentioned application logic in the required format; and

transfer of the application program logic through the specified mobile data transfer channel to an end user device.

In one particular embodiment of the method the program logic is built on the server end.

In another particular embodiment of the method the interface parameters include: functions of the elements, visual parameters of the interface, interaction of the elements among themselves, order of the elements, combinations of the elements; wherein the interface parameters being compared with a database containing the interface data of the program logic of the elements, and the comparison is performed for each mobile channel.

### BRIEF DESCRIPTION OF DRAWINGS

FIG. 1 shows a general view of the system.

FIG. 2 shows the basic elements included in the system.

FIG. 3A shows the detailed interaction of system elements.

FIG. 3B shows the steps of the conversion of the application's logic format.

FIG. 4 illustrates an example of converting an application interface into a chat bot channel.

### DETAILED DESCRIPTION OF INVENTION

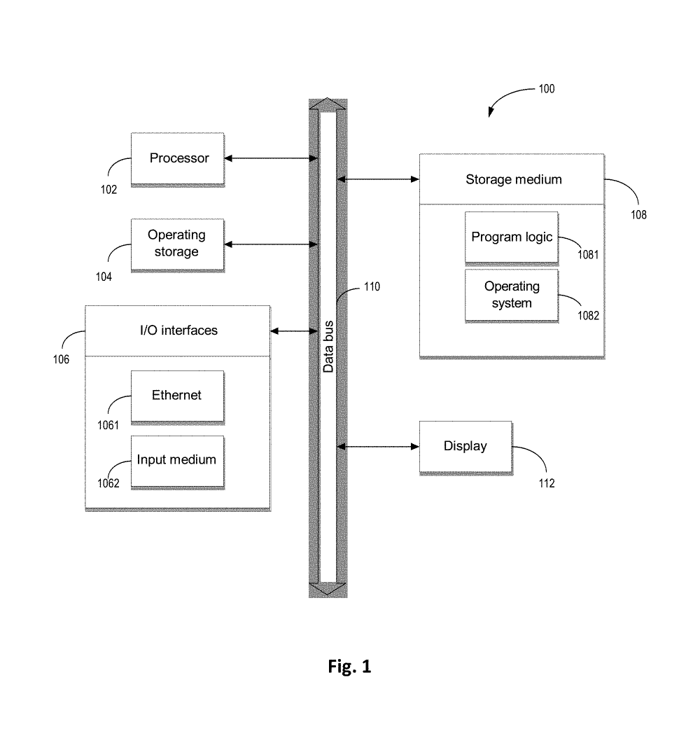

As represented in FIG. 1, the claimed system (100) is performed on an electronic computing device, which in a general case contains: one or more processors (102), random access memory (RAM) (104), input/output interfaces (I/O) (106), data storage medium (108) and display (112), connected by a common data bus (110).

In a general case, the necessary components for the operation of the claimed invention are such components as the Ethernet interface (1061) for connecting to an external data network, such as the Internet, and an interface for connecting an information input medium (1062), such as USB or PS/2. In addition to the Ethernet interface (1061), the computing device that implements the claimed system (100) may also contain various tools, for example, a Wi-Fi module, a NFC module, a Bluetooth module, which allow to exchange the data, both through wired and wireless data transfer channels.

A data storage medium (108) may represent a HDD or SSD disk, or a device based on Flash memory, or optical disks, for example, a CD, DVD or Blue-Ray, or a combination of various means depending on the configuration of the computing device.

The storage medium (108) contains a program logic (1081) that executes the basic functionality of the claimed solution, as well as the operating system (1082), which allows for user interaction with the platform for building software applications. The operating system can be from a Mac OS, Windows or Linux family.

Interaction with the system can also be carried out using the means of touch input, for example, a touchscreen display, touch pad, or combinations thereof.

In addition to RAM (104), ROM and/or NAND-flash memory can be used.

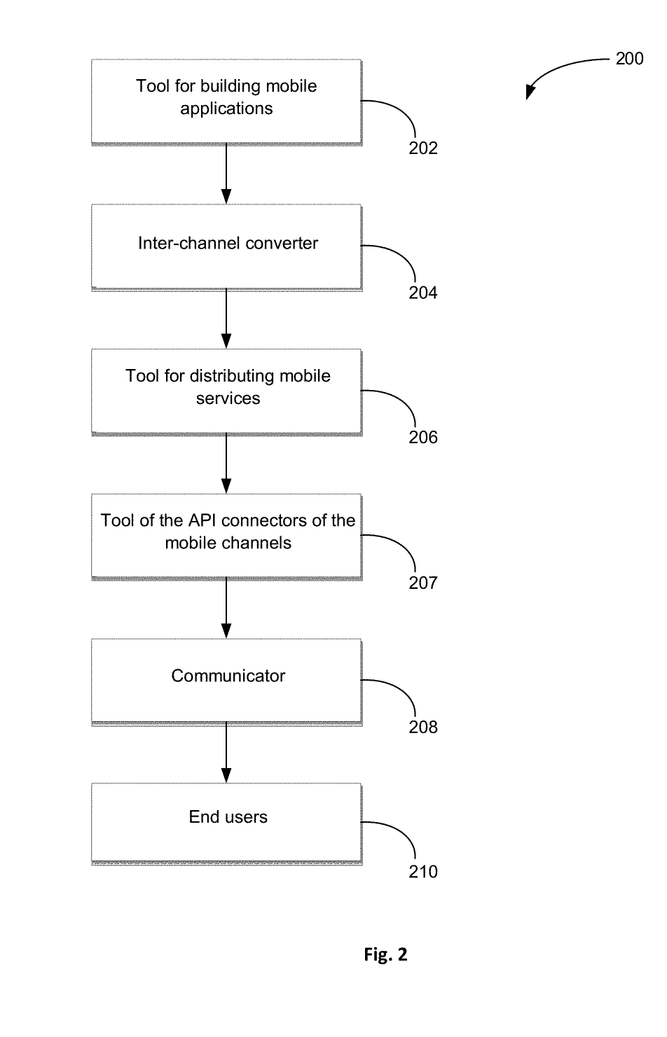

The FIG. 2 shows the main components that make up the claimed platform (200) for building mobile applications and their management, such as: a tool for building mobile applications (202), an inter-channel converter (204), a tool for distributing mobile services (206), a tool of API connectors of mobile channels (207), a communicator (208) and the end-user devices (210).

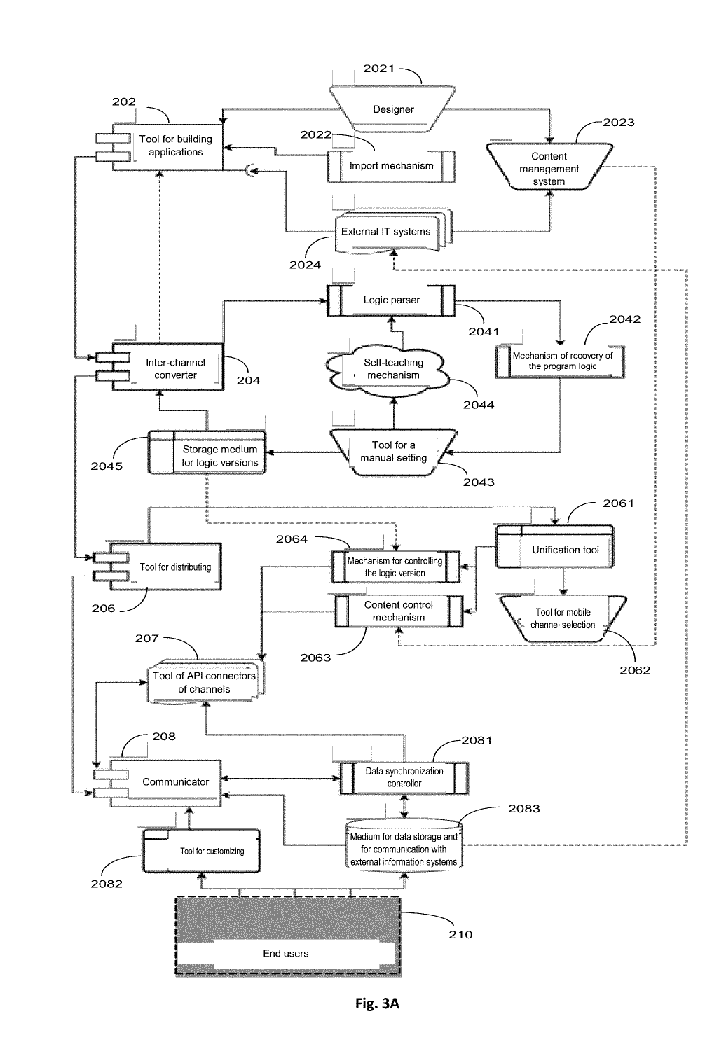

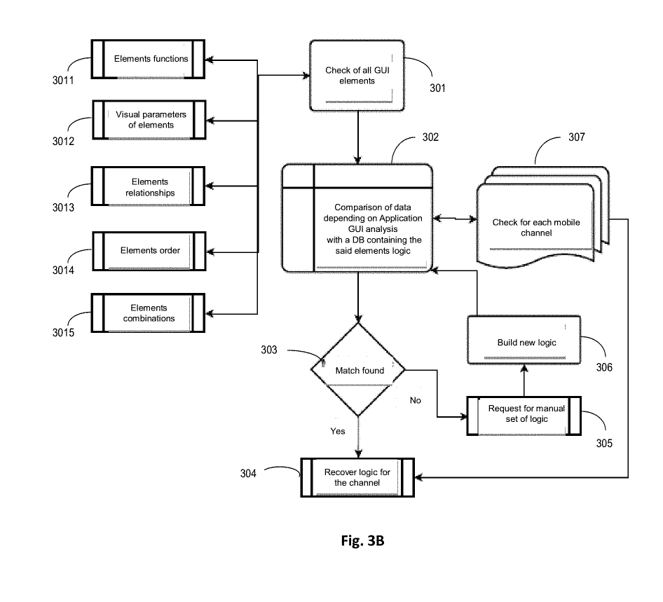

The main tool for building mobile applications (202) is designed to create a new application's program logic. As represented in FIG. 3 the building of the applications is carried out using the mechanism of the application visual design (2021). This mechanism (2021) allows you to build applications using visual design based on a set of application elements, for example, user graphical interface elements (GUI) and commands associated with these elements.

The application's logic can also be imported using the import mechanism (2022), which allows loading logic in a supported format. The program logic can be represented as templates.

The applications building tool (202) also includes a content management system (CMS) (2023), which allows processing of content for various mobile data transfer channels. The system (2023) provides a centralized storage of applications, a graphical and a logical representation of the content. The graphical representation of the content may be grouped depending on the type of mobile channel and the dominant elements of the graphic interface of the application according to the type of interface (GUI, Text UI, Voice UI etc.). The system (2023) also provides a content synchronization between mobile channels.

The mechanism (202) also includes tools of communication with external information systems (2024).

To build mobile applications in the required format, an inter-channel converter (204) is used, which allows you to convert applications logic. A tool for parsing of the applications' program logic (2041) (parser) analyses the interface elements of the application, which includes: analysis of the degree of use of interface elements, combinations of interface elements, relations between interface elements.

The applications processed by the parser (2041) are transmitted further to the mechanism of recovery of the application's program logic for various mobile data transfer channels (2042). This tool (2042) allows to adapt the logic for the desired mobile channel; for this end, the program logic of the application is analyzed and the need to change the logic for a given mobile data transfer channel is determined. If the logic adaptation cannot be performed in automatic mode, then the mechanism for manual setting of the procedure for creating applications (2043) is used, with which it is possible make the necessary changes to the application logic. The above steps for setting up the application logic can be transferred to the self-teaching mechanism (2044) for subsequent automatic use of the logic conversion procedures. The self-teaching mechanism (2044) is designed to detect various tasks, and also allows to determine the most frequently used interface settings of the application that need to be done manually. The parser (2041) is updated using the self-teaching mechanism (2044), which subsequently reduces the number of manual operations required to convert the application logic.

In its structure the manual setting mechanism (2043) is similar to the visual design mechanism (2021) and allows to preview the results of application logic processed by the parser (2041) or the logic recovery mechanism (2042) and set the necessary elements using means of visual processing. Also, this mechanism (2043) allows to customize the UI logic for each mobile channel, without the need to make changes to the logic of other channels.

The converter (204) also includes a tool for separate storage of versions of the application logic for each of the mobile channels (2045).

The tool for distributing mobile services (206) is a means for transmitting created applications through the mobile data transfer channels. The mechanism (206) contains a data unification tool (2061), which is associated with the mechanism for controlling the version of the application logic (2064) and the content control mechanism (2063). The unification tool (2061) is also connected to the selector of a mobile data transfer channel (2062). The channel selector (2062) is a mechanism that contains the tools to select the desired mobile channel, add a mobile application to a specific channel, seamlessly switching between mobile channels, and also provide routing of communications through the selected channel.

The mechanism (206) provides an exchange of data between mobile channels in a unified form.

The mechanism for controlling the version of the application logic (2064) provides the transfer of the correct logic of the application version, for which purpose it uses the correct version of the unified logic for the mobile channel API. The transmission of the program logic for the selected mobile channel is performed in accordance with the parameters of the said channel, for which a comparison is made of the application's program logic version and the parameters of the mobile channel and, based on the performed check, the correct version of the application's program logic is determined and transmitted through the selected mobile channel.

The content control mechanism (2063) is designed to transmit the appropriate content, in particular, the correct version of the content for the API of the selected mobile channel.

From the mechanism (2064) and the mechanism (2063) the content parameters are transmitted to the tool of the API connectors of the mobile channels (207).

From the mechanism (206), the processed data is transmitted to the communicator (208), which represents a set of tools for communication and synchronization of the applications transmitted via mobile data transfer channels. The communicator (208) contains a controller for synchronizing data transmitted between different channels (2081), a tool for customizing the data transfer mode (2082) and a medium for data storage and for communication with external information systems (2083).

The controller (2081) provides data transmission through the mobile channels according to the technical specification of each channel, and also includes means for receiving responses from each of the APIs of mobile data transfer channels and distributing said responses to maintain synchronization of mentioned mobile channels.

The configuration tool (2082) allows to select different communication modes, in particular, a global mode, a mode for the selected mobile channel, a mode for the type of mobile channel, a mode for the selected application. For different types of mobile channels, different combinations of the mentioned modes can be used.

The storage device (2083) contains information about files, messages, statuses, user devices, user settings, UID, supported applications, and the availability of mobile channels. This information is accumulated in response to receiving signals from end users (210) and is transmitted to the communicator (208).

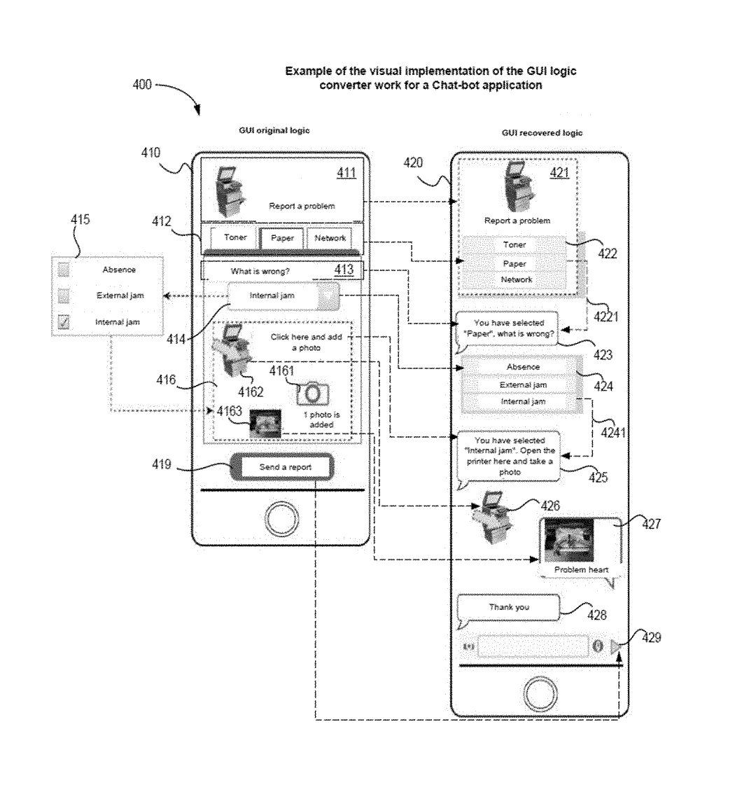

The FIG. 4 shows the more detailed mechanism for converting the program logic using the converter (204). At step (301) the features of the software application interface are checked, in which the following GUI parameters are analysed using the parser (2041): actions performed by elements (functions of elements) (3011), visual parameters of GUI elements (3012), connections of elements between themselves (3013), order of elements (3014), combinations of elements (3015).

After that, at step (302) the information obtained when analysing the GUI elements at step (301) is compared with the database that stores information about the logic of the interface elements. While performing the above-mentioned comparison with the database in the step (303) the matching logic is searched; if the matching logic is found, then at step (304) the logic is rebuilt to the required format. If at step (303) a match is not found, then at step (305) it is proposed to carry out the application logic conversion in manual mode. After manual modification of the logic at step (305), a new logic (306) is built, which is transferred to the program logic database. When performing the logic conversion procedure, this procedure is performed for each mobile channel (307), based on the features of the channel API.

The FIG. 5 shows an example of converting software logic for a chat-bot system (400). The screen of the electronic device displays the initial application logic (410), which can be built or imported according to the claimed solution, containing a given set of interface elements and related functional parameters. The logic (410) contains a set of options (412), which are designed to select the necessary category and perform the subsequent consequences of user actions when interacting with the chat-bot application (420) with the rebuilt logic (410).

The subject of the chat-bot dialogue (421) is created on the basis of the given theme of the initial logic (411), in particular, the solution of the technical problem of printer breakdown. The options of interaction types (412) are converted into the logic (422) of the chat-bot application and displayed on the screen of the device performing the rebuilt logic (420).

Depending on the selected function (412), which allows to describe the failure, the following logic unit (413) offers a set of related actions (414) in the corresponding interface area. When performing the process of rebuilding of these logic interface elements (410), they are analysed for possible states (415) and subsequent generations of the interface type, depending on the scenarios (416) associated with the mentioned states (415).

While choosing the option “Internal jam” (414), the interface logic (410) forms the area (416) of the subsequent interaction with the user, which contains functional elements of the interface, such as: a graphic indication to a subject matter (4162), for example, a printer, or its part in which a technical failure occurred and which the user should pay attention to; a tool for creating a graphic file (4161), which enables the camera of the device to take a photo or make a video clip; the pictographic display area of the created file (4163) using the tool (4161).

The elements of the initial logic (410) are rebuilt to the logic of the chat-bot channel (420), with the generation of the corresponding display of interface elements in a format that ensures the sequential execution of the necessary actions when dialoguing between the user and the intelligent chat-bot system.

The corresponding logic of the interface elements (411) describing the chat-session subject is rebuilt and recreated as the final logic of the chat-bot application (421). The interaction types (412) are also rebuilt into the corresponding interface elements (422) of the final logic (420).

When one of the options (422) is selected, the associated function of the chat application (423) is enabled, which subsequently generates the display of interface elements with the options (424) associated with the previously selected (422) chat session.

The corresponding links (4221, 4241) represent the display of the relationship between the selectable types of options (422, 424) with the further construction of a dialogue between the chat-bot application and the user.

The functionality of the set of interface elements (416) of the initial logic is reconstructed as a set of interface elements (426, 427). The user sees an object or its part with an indication of the area whose graphic image is to be obtained. After the chat application has received such an image (427), the application logic (420) notifies the user of its receipt by the corresponding dialog box (428).

The element of sending the chat session report (419) of the initial logic (410) is implemented into the corresponding functional element (429) of the chat-bot application logic (420).

The presented example is only a special case of creating and converting logic to the chat-bot channel of the application. The application represented by the logic (410) can be of any nature and contain more extended functionality.

1. A system for building and managing mobile applications, containing:
at least one processor;
at least one storage that contains program instructions that, when executed, implement on at least one processor
tool for building mobile applications in a given format;
tools for converting the built mobile applications from one format to another, which include at least an application program logic parser that analyses the interface elements of the application;
tools for transmitting the built applications through mobile data transfer channels in a given format for each channel;
tools of communication and synchronization of applications transmitted through mobile data transfer channels.

2. The system according to claim 1, characterized in that the tools for building mobile applications comprise a visual design mechanism that provides the building of an application using a set of application elements.

3. The system according to claim 1, characterized in that it contains a content management system (CMS) for various mobile channels, which provides a centralized storage of applications, a graphical representation of the content, a logical representation of the content and the synchronization of the content and the operation logic between different mobile channels.

4. The system according to claim 1, characterized in that the graphical representation of the content is grouped depending on the type of the mobile channel and the dominant elements of the graphical interface of the application.

5. The system according to claim 1, characterized in that it contains means of communication with external information systems.

6. The system according to claim 1, characterized in that the analysis of application elements using a parser includes: analysis of the degree of use of interface elements, combinations of interface elements, relations between interface elements.

7. The system according to claim 1, characterized in that the tools for converting the built mobile applications contain a means of recovery of the application's program logic for various mobile data transfer channels, which receives information from the parser, analyses the program logic of the application and determines the need to change the logic for a given mobile data transfer channel.

8. The system according to claim 1, characterized in that the tools for converting the built mobile applications contain a self-teaching mechanism designed to detect various tasks and determining the most frequently used settings of the application interface.

9. A system according to claim 8, characterized in that the self-teaching mechanism performs updating of the program logic parser.

10. The system according to claim 1, characterized in that the means for transmitting the built applications through the mobile data transfer channels comprise the data unification mechanism that provides an exchange of data between mobile channels in a unified form.

11. The system according to claim 1, characterized in that the tools for transmitting the built applications through mobile data transfer channels contain a tool for selecting a mobile data transfer channel and a mechanism for transmitting the program logic of the mobile channel corresponding to the parameters of the said channel and that performs a comparison of the application program version and mobile channel parameters.

12. The system according to the claim 11 characterized in that the tools for transmitting the built applications through the mobile data transfer channels additionally comprise a means for seamless switching between different mobile data transfer channels.

13. The system according to the claim 11 characterized in that the mechanism for transmitting program logic, based on the check performed, determines the correct version of the application's program logic for transmission through the selected mobile channel.

14. The system according to claim 1, characterized in that the means for transmitting the built applications through the mobile data transfer channels comprise the mechanism for the transfer of a appropriate content provides the transfer of the content version corresponding to the mobile data transfer channel API.

15. The system according to claim 1, characterized in that the tools of communication and synchronization of applications comprise a tool for analysing the technical parameters of mobile data transfer channels, and means for receiving responses from each of the APIs of mobile data transfer channels, as well as for distributing responses to maintain synchronization of mentioned mobile channels.

16. The system according to claim 1, characterized in that the tools of communication and synchronization of applications additionally comprise a tool for setting up a user mode of communication, which is selected from the group: global mode, mode for the selected mobile channel, mode for the type of mobile channel, mode for the selected application or combination thereof.

17. The system according to claim 1, characterized in that the tools for communication and synchronization of applications additionally comprise a medium for data storage and for communication with external information systems, which contains information about files, messages, statuses, user devices, user settings, UID, supported applications and mobile channels accessibility.

18. A computer-implemented method for building and managing mobile applications, comprising the following steps:
reception of the original application data using an application designer, which contains a set of application elements;
generation of an application program logic;
determination of a format of the mobile application's program logic depending on the type of a mobile data transfer channel, upon that at least it is performed the analysis of the API of the mobile channel through which it is necessary to transmit the program logic to determine the format of the application's program logic and a parameters of the application interface elements;
conversion of the application's program logic depending on the mobile data transfer channel API;
representation of the mentioned application logic in the required format; and
transfer of the application program logic through the specified mobile data transfer channel to an end user device.

19. The method according to claim 18, characterized by that the program logic is built on the server end.

20. The method according to claim 18, characterized in that the interface parameters include: functions of the elements, visual parameters of the interface, interaction of the elements among themselves, order of the elements, combinations of the elements; wherein the interface parameters being compared with a database containing the interface data of the program logic of the elements, and the comparison is performed for each mobile channel.
